(19) United States
(12) Patent Application Publication
(10) Pub. No.: US 2025/0016103 A1
(43) Pub. Date: Jan. 9, 2025

(54) SESSION-BASED LOAD BALANCING

(71) Applicant: MAXLINEAR, INC., Carlsbad, CA (US)

(72) Inventors: Arnon Meydav, Kfar-Saba (IL); Nimrod Kamieniecki, Hod-Hasharon (IL)

(73) Assignee: MAXLINEAR, INC., Carlsbad, CA (US)

(21) Appl. No.: 18/764,121

(22) Filed: Jul. 3, 2024

Related U.S. Application Data
(60) Provisional application No. 63/511,845, filed on Jul. 3, 2023.

(51) Int. Cl. H04L 47/125; H04W 28/088

(52) U.S. Cl. CPC H04L 47/125; H04W 28/088

(57) ABSTRACT

A method includes obtaining a first session packet of multiple session packets belonging to a session, where the session may be queued to be transmitted between a first network device and a second network device. The method also includes assigning the first session packet to a first network link based on a link weight determined for the first network link between the first network device and the second network device. The method further includes queuing the first session packet to be transmitted from the first network device to the second network device via the first network link. The method also includes obtaining a second session packet of the plurality of session packets. The method further includes assigning the second session packet to the first network link.

### CROSS REFERENCE TO RELATED APPLICATIONS

This U.S. patent application claims priority to U.S. Provisional Patent Application No. 63/511,845, titled “SESSION-BASED LOAD BALANCING,” and filed on Jul. 3, 2023, the disclosure of which is hereby incorporated by reference in its entirety.

### TECHNICAL FIELD

This disclosure generally relates to network communications, and more specifically, to session-based load balancing across network links.

### BACKGROUND

Unless otherwise indicated herein, the materials described herein are not prior art to the claims in the present application and are not admitted to be prior art by inclusion in this section.

Networking devices may be linked with other devices via one or more network links. Networking devices may include routers, gateways, access points, and the like. Some network links may be wireless connections and some network links may be wired connections. In instances in which network links are wireless connections, Institute of Electrical and Electronics Engineers (IEEE) 802.11 standards include protocols for implementing wireless local area network (WLAN) communications, including Wi-Fi.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a device may include a first network link and a second network link. The device may be operable to obtain a first session packet of a plurality of session packets belonging to a session, where the session may be queued to be transmitted from the device. The device may further be operable to assign the first session packet to the first network link based on a link weight determined for the first network link, the first network link connecting the device to a second device. The device may also be operable to queue the first session packet to be transmitted via the first network link. The device may further be operable to obtain a second session packet of the multiple session packets. The device may also be operable to assign the second session packet to the first network link.

In another embodiment, a method may include obtaining a first session packet of multiple session packets belonging to a session, where the session may be queued to be transmitted between a first network device and a second network device. The method may also include assigning the first session packet to a first network link based on a link weight determined for the first network link between the first network device and the second network device. The method may further include queuing the first session packet to be transmitted from the first network device to the second network device via the first network link. The method may also include obtaining a second session packet of the plurality of session packets. The method may further include assigning the second session packet to the first network link.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for session-based load balancing;

FIG. 2 illustrates a block diagram of session-based load balancing;

FIG. 3 illustrates a flowchart of an example method of session-based load balancing;

FIG. 4 illustrates a flowchart of an example method of session-based load balancing; and

FIG. 5 illustrates an example computing device.

### DETAILED DESCRIPTION

Some communication channels between network devices may include one or more network links. In instances in which the communication channels include more than one network link, communications in the network between the network devices (e.g., via the network links) may experience improved reliability, decreased latency, and/or an improved throughput. For example, the multiple network links may be utilized in parallel or substantially the same time to transmit network traffic between the network devices.

The IEEE 802.11be amendment to the IEEE 802.11 standard facilitates wireless local area networks (LANs) supporting data transmissions (e.g., network traffic) using simultaneous multiple network links to a single receiving device, which may improve throughput, latency, and/or reliability of data transmissions between network devices included in the LAN. Network traffic using simultaneous multiple links to a single receiving device is called multi-link operation (MLO), including simultaneous transmit-receive (STR) through a multi-link device (MLD).

IEEE 802.1AX (previously IEEE 802.3ad) defines link aggregation of Ethernet connections. For example, in Linux, network interface bonding may be an implementation of link aggregation of Ethernet connections. Continuing the example, a Linux bonding driver may support round robin packet load balancing and/or active backup (e.g., where a first slave interface is active and a second slave interface may become active in instances in which the first slave interface fails). In such systems, there may not be a definition and/or handling of load balancing between asymmetric network links.

In real-world network traffic scenarios (e.g., a download of a web page containing embedded objects, a download by file sharing protocols, simulated high-throughput traffic through a traffic generator, etc.), the network traffic may be received through multiple sessions. In some circumstances, the network traffic may include transmission control protocol, internet protocol (TCP/IP), user datagram protocol, internet protocol (UDP/IP), and/or other network protocols. In some existing systems and devices, network traffic may be spread intra-session between the network links. For example, each packet included in a session may be individually forwarded (e.g., without respect to the forwarding of other packets included in the session) to any of the network links included in the network. In such instances, any interference and/or delays that may result in a degradation or loss of service (e.g., reduced or failed network traffic) on a particular network link of the network links may cause a corresponding throughput reduction, network traffic loss, and/or increased latency to the session packets that are transmitted on the other network links.

In some prior approaches, as a session (e.g., including session packets) is obtained by the transmit device for transmission in the network, the session packets may be distributed between the network links included in the network. For example, a particular session may be obtained in an ingress queue of a transmit device and the session packets of the particular session may be distributed between the network links in the network for transmission. In instances in which particular network link of the network links experiences interference, delays, and/or a reduction of service, a decrease in throughput, network traffic loss, and/or increased latency may be experienced by all other network links included in the network.

In an example, a network may include three network links including a first network link, a second network link, and a third network link. The ingress queue of the network may include multiple sessions, each of which may include one or more session packets. The prior approach may distribute the session packets between the three network links, without regard to the session to which the session packets belong. As such, a first session may include one or more first session packets assigned to the first network link, the second network link, and/or the third network link. In instances in which interference causes delays or network traffic loss to the first session packets assigned to the first network link, the first session packets assigned to the second network link and/or the third network link may also cause delays upon reception by a receiving device, as the reordering of the first session packets may be delayed until the first session packets transmitted using the first network link are received by the receiving device. Alternatively, or additionally, the delay associated with the first session (e.g., the first session packets on the first network link) may cause a delay to the other sessions on any of the network links (e.g., the second network link and/or the third network link) as the delayed/failed first session packets may be retransmitted resulting in delays to the other network links, the other sessions, and/or the other session packets.

In these and other prior approaches, as a network link degrades (such as due to interference, noise, or other network issues), managing the effects of degradations to the network link on other network links in the network, due to the sharing of common resources between the network links, is unaddressed.

Aspects of the present disclosure address these and other limitations by using a session-based load balancing approach which may spread network traffic (e.g., session packets) between network links in a network according to the session to which the session packets belong. For example, network traffic may be spread between the network links included in the network on a per session basis, where all session packets included in a particular session may be forwarded to one network link. Alternatively, or additionally, the distribution of the session packets may be in view of a capacity (e.g., a bandwidth) of the network links to account for instances in which the network links may be asymmetrical in capacity. For example, a weight may be determined that may be used to select a particular network link for transmission of the session and/or session packets based on a ratio between an estimated throughput associated with the individual network links in the network.

In these and other embodiments, the session-based load balancing may be applied to LAN link aggregation (e.g., the network interface bonding as described herein) and/or to IEEE 802.11 (and/or amendments thereto) multi-link operations. For example, the session-based load balancing may be used with wired networks, such as using Ethernet or other wired connections, and/or wireless networks, such as Wi-Fi 7.

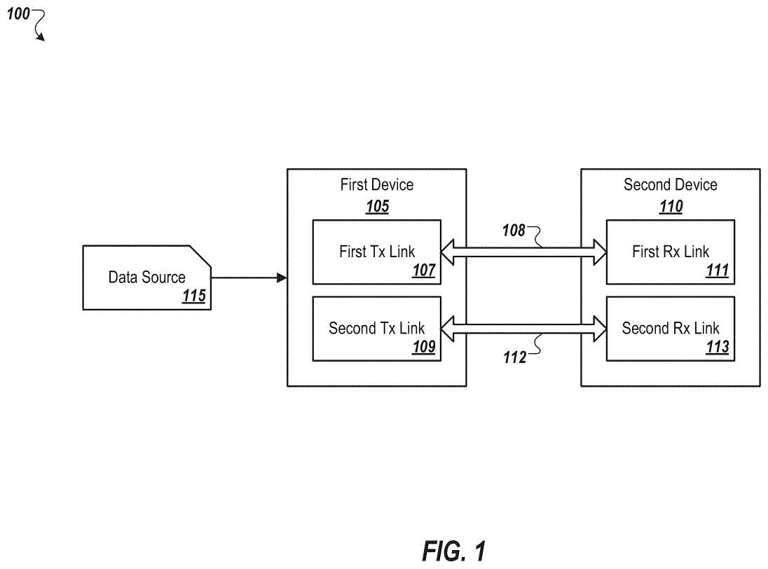

FIG. 1 illustrates a block diagram of an example system 100 for session-based load balancing, in accordance with at least one embodiment of the present disclosure. The system 100 may include a first device 105 and a second device 110. The first device 105 may include a first transmit link 107 and a second transmit link 109. The second device 110 may include a first receive link 111 and a second receive link 113.

The first device 105 may be a network device that may be operable to transmit and/or receive network traffic. In the present disclosure, the first device 105 may be referred to as a transmit device, but operation of the first device 105 as a receiving device is also contemplated. The first device 105 may be operable to facilitate transmissions of network traffic in a network that utilizes wired connections (e.g., Ethernet) or wireless connections (e.g., Wi-Fi 7). In instances in which the system 100 is a wireless network and is a mesh network, the first device 105 may be one node in the mesh network and the second device 110 may be a second node, and additional nodes may be present such that network traffic may be transmitted from one or more nodes to one or more nodes in the mesh network and/or any of the nodes in the mesh network may be operable to perform the operations described herein relative to the first device 105 and/or the second device 110. The first device 105 may be operable to use multiple links to transmit the network traffic, such as the first transmit link 107 and/or the second transmit link 109.

In some instances, the first device 105 may obtain network traffic from a data source 115 and may transmit the network traffic to another device or system, such as the second device 110. The first device 105 may be a gateway, a router, an access point, a bridge, a switch, and/or other transmit device operable to transmit network traffic using one or more network links (e.g., a multi-link device).

The second device 110 may be similar to the first device 105 in that the second device 110 may be operable to transmit and/or receive network traffic. In instances in which the second device 110 is operable to receive network traffic, the second device 110 may be any non-access point multi-link device operable to receive network traffic on one or more network links included therein (e.g., the first receive link 111 and/or the second receive link 113). In the present disclosure the second device 110 may be referred to as a receiving device, but operation of the second device 110 as a transmit device is also contemplated.

The network traffic obtained by the first device 105 may be separated into one or more sessions, such that each session may individually include one or more session packets. Further, the network traffic (e.g., the session packets) may be transmitted from the first device 105 to the second device 110 via the network links associated with the first device (e.g., the first transmit link 107 and/or the second transmit link 109) and the second device 110 (e.g., the first receive link 111 and/or the second receive link 113). In some embodiments, the first device 105 may be configured to perform a balancing operation relative to the network traffic in view of the network links between the first device 105 and the second device 110, as described herein. In some embodiments, the balancing operation may be determined based on a desired performance of the network. For example, in some instances, a computational least-cost method may be determined. In another example, in some instances, a real-time adaptive calculations may be determined.

The first device 105 may obtain a particular session packet in an ingress queue and the first device 105 may determine and a first session associated with the particular session packet (e.g., a session to which the particular session packet belongs). The first device 105 may determine the first transmit link 107 may be used to transmit the particular session packet to the second device 110, and the particular session packet may be assigned to the first transmit link 107.

In some embodiments, the first device 105 may store the assignment of the particular packet to the first transmit link 107. Alternatively, or additionally, the first device 105 may store a configuration associated with the assignment of the particular packet to the first transmit link 107. The configuration and/or assignment of the particular packet to the first transmit link 107 may be stored and/or used to determine a transmit link for transmitting additional session packets that belong to the first session, similar to the particular session packet. For example, in instances in which a second session packet included in the first session is added to the ingress queue, the first device 105 may assign the second session packet to the first transmit link 107, which may be the same transmit link as the particular session packet, where the particular session packet and the second session packet are both included in the first session.

Alternatively, or additionally, in instances in which the first device 105 determines a last session packet of a particular session has been queued and/or transmitted (e.g., all of the network traffic from the particular session has been queued and/or transmitted), the first device 105 may erase the stored configuration and/or association between the particular session and the first transmit link 105 and/or the stored association between the session packets of the particular session and the first transmit link 105. Alternatively, or additionally, the first device 105 may be configured to erase the stored configuration and/or association based on factors associated with the particular session and/or the particular session packets. For example, the first device 105 may erase the stored configuration after a threshold amount of time has elapsed since transmitting a session packet from the particular session. In another example, the transmit device may erase the stored configuration after a threshold number of session packets have been transmitted.

As described herein, the sessions to be transmitted via the first network link 108 and/or the second network link 112 in the network may be distributed between the first transmit link 107 and the second transmit link 109. In some instances, a link weight may be determined for the first transmit link 107 and the second transmit link 109, and the link weights may be used in determining the distribution of the session assignments to the transmit links. In some instances, the link weight may be based on the connection type of the network (e.g., a wired connection or a wireless connection) and/or the links weight may be determined using a computation, where multiple computations may be available for determining the link weight and the multiple computations may vary in computational complexity.

A first computation may include determining a first link rate associated with the first network link 108 (e.g., the link rate between the first transmit link 107 and the first receive link 111) and/or determining a second link rate associated with the second network link 112, and determining a ratio between the first link rate and the second link rate.

For example, in instances in which the system 100 is a wireless network, determining which transmit link (e.g., the first transmit link 107 or the second transmit link 109) to select in the first device 105 for one or more session packets in a particular session may include determining a first bandwidth, a second bandwidth, and a ratio between the first bandwidth and the second bandwidth. Based on the ratio, the session packets may be assigned to the determined transmit link. In another example, in instances in which the system 100 is a wired network, determining which transmit link to select in the first device 105 for the session packets in the particular session may include determining a first negotiated physical layer (PHY) rate, a second negotiated PHY rate, and a ratio between the first negotiated PHY rate and the second negotiated PHY rate. Based on the ratio, the session packets may be assigned to the determined transmit link.

In these or other embodiments, determining the ratio between the first transmit link 107 and the second transmit link 109 may provide an estimate of the throughput of the first network link 108 and the second network link 112 under ideal conditions. In some embodiments, the first computation may not account for variations in the first link rate and/or the second link rate (e.g., the bandwidth and/or the negotiated PHY rate) over time, which variations may be due to issues in the first network link 108 and/or the second network link 112 including, but not limited to, network traffic congestion, interference, and/or reception issues.

A second computation may include determining a first rolling average PHY rate associated with the first network link 108 and/or determining a second rolling average PHY rate associated with the second network link 112, and determining a ratio between the first rolling average PHY rate and the second rolling average PHY rate. In some instances, an initial PHY rate may be determined for the first network link 108 and/or for the second network link 112, and upon subsequent transmissions of network traffic via the first network link 108 and/or the second network link 112 (e.g., after transmission of a session packet and/or after transmission of a session), a subsequent PHY rate may be determined and combined with the initial PHY rate to obtain the rolling average PHY rate. In some embodiments, a PHY rate may be determined after each transmission and/or after a threshold number of transmissions and subsequently, the first rolling average PHY rate and/or the second rolling average PHY rate may be updated with each determination. In these and other embodiments, the rolling average PHY rate may be determined for each channel in the system 100, such as the first network link 108 and the second network link 112.

A third computation may include determining a first rolling average data rate associated with the first network link 108 and/or determining a second rolling average data rate associated with the second network link 112, and determining a ratio between the first rolling average data rate and the second rolling average data rate. For example, the rolling average data rate may take into consideration the link rate of a particular channel (e.g., the first network link 108 and/or the second network link 112) and/or delays associated with the particular channel that may be caused by channel availability and/or retransmissions by the associated transmit link (e.g., the first transmit link 107 and/or the second transmit link 109).

In these and other embodiments, the link weights may be initially determined and may be used to distribute the sessions to be transmitted from the first transmit link 107 and/or the second transmit link 109. Alternatively, or additionally, the link weights may be updated in response to a threshold being satisfied, and the updated link weights may be used to distribute the sessions to be transmitted from the first transmit link 107 and/or the second transmit link 109. In some instances, the link weights may be updated in response to satisfying a threshold amount of elapsed time. Alternatively, or additionally, the link weights may be updated in response to satisfying a threshold number of transmitted sessions and/or a threshold number of transmitted session packets.

In some instances, once a first session packet from a particular session is assigned to a transmit link based on the computations described herein, the remaining session packets from the particular session may be assigned to the same transmit link, without additional computations. For example, in instances in which a first packet belonging to a first session is assigned to the second transmit link 109 based on the second computation, the subsequent session packets belonging to the first session may be assigned to the second transmit link 109, without any additional computations.

Alternatively, or additionally, first session packets from a first session may be assigned to the same transmit link as second session packets from a second session, based on the computations described herein. For example, a first session packet belonging to a first session may be assigned to the first transmit link 107 based on the link weight associated with the first transmit link 107 (relative to the link weight associated with the second transmit link 109) and a second session packet belonging to a second session may be assigned to the first transmit link 107, even after the first session packet has been assigned to the first transmit link 107. In the example, the link weight for the first transmit link 107 and the second transmit link 109 may be recalculated after the assignment of the first session packet to the first transmit link 107 and in view of the recalculated link weights, the second session packet may be assigned to the first transmit link 107.

In some instances, after a first session packet of a particular session is assigned to a particular transmit link (e.g., the first transmit link 107 or the second transmit link 109), the first session packet may be queued for transmission by the particular transmit link. Alternatively, or additionally, assigning the first session packet to a particular transmit link and queueing the first session packet for transmission by the particular transmit link may be performed in the same operation. For example, as a first session packet is assigned to the first transmit link 107, the first session packet may be queued for transmission via the first transmit link 107.

In instances in which the first transmit link 107 and/or the second transmit link 109 has one or more session packets in a corresponding queue, the first transmit link 107 may transmit the queued session packets to the first receive link 111 via the first network link 108 and/or the second transmit link 109 may transmit the queued session packets to the second receive link 113 via the second network link 112. As described herein, all session packets belonging to a particular session may be transmitted via the same network link (e.g., all session packets via the first network link 108 or all session packets via the second network link 112).

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

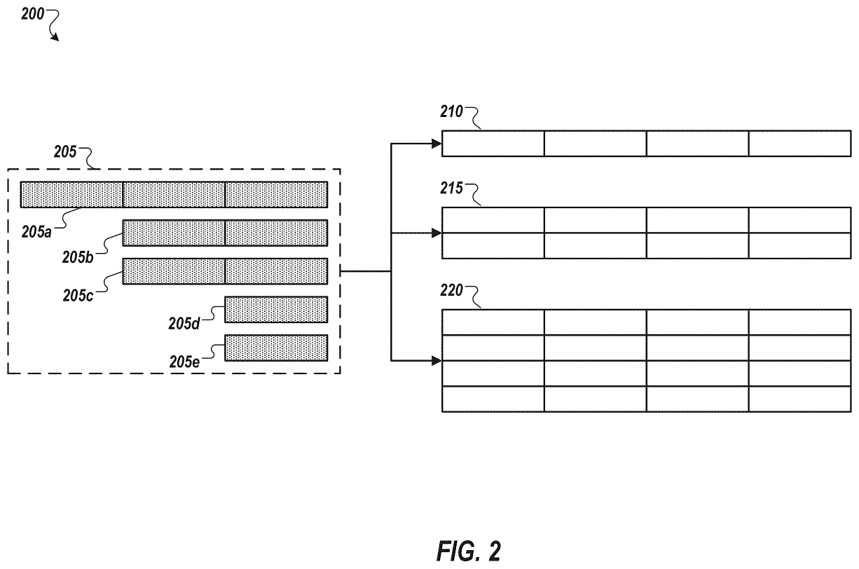

FIG. 2 illustrates a block diagram 200 of session-based load balancing, in accordance with at least one embodiment of the present disclosure. The diagram 200 may include first session packets 205a, second session packets 205b, third session packets 205c, fourth session packets 205d, and fifth session packets 205e, referred to collectively as session packets 205, a first channel 210, a second channel 215, and a third channel 220.

In some instances, network links (e.g., the first network link 108 and/or the second network link 112 of FIG. 1) may be a representation of one or more channels. As illustrated, the first channel 210, the second channel 215, and/or the third channel 220 may have different characteristics from one another, such as each of the channels having a different bandwidth. For example, the first channel 210 may have a bandwidth of 20 MHz, the second channel 215 may have a bandwidth of 40 MHz, and the third channel may have a bandwidth of 80 MHz. Alternatively, or additionally, the first channel 210, the second channel 215, and/or the third channel 220 may have similar characteristics to one another, such as a bandwidth associated therewith. For example, each of the first channel 210, the second channel 215, and the third channel 220 may have a bandwidth of 40 MHz.

The channels may be individually assigned a link weight, such as by one of the computations described herein. Using the link weights and/or ratios between the link weights, the session packets 205 may be assigned and/or queued to the channels, on a per session basis. In some instances, the link weight may be associated with the available bandwidth of the channel. For example, the first channel 210 may have a link weight of one, the second channel 215 may have a link weight of two, and the third channel 220 may have a link weight of four. In some instances, the link weight may be determined prior to any session packets 205 being assigned to the channels. Alternatively, or additionally, the link weights may be updated after one or more of the session packets 205 are assigned to the channels.

In an example, the first session packets 205a may be assigned to the third channel 220 based on a ratio of link weights, the second session packets 205b may be assigned to the second channel 215 based on the ratio of link weights, the third session packets 205c may be assigned to the third channel 220 based on the ratio of link weights, and so forth. In these and other embodiments, all of the session packets belonging to a particular session may be assigned to the same channel. For example, all of the first session packets 205a may be assigned to the third channel 220 (or any other channel selected, based on the link weights and/or the ratios between them).

In some instances, the session-based load balancing as described relative to the diagram 200 of FIG. 2 may limit interference associated with a particular channel (e.g., the first channel 210) to sessions transmitted using the particular channel (e.g., the interference may limit the throughput of the first channel 210). Alternatively, or additionally, the interference in the particular channel may not affect throughput of sessions transmitted using the other channels in the network (e.g., the second channel 215 and/or the third channel 220).

Modifications, additions, or omissions may be made to the diagram 200 without departing from the scope of the present disclosure. For example, there may be more or less sessions and/or session packets than illustrated for a particular system. Alternatively, or additionally, more or less channels may be included in a system than illustrated in the diagram 200. Alternatively, or additionally, the channels may have various amounts of bandwidth and/or may be operable to support more or less session packets in a transmission than illustrated.

In another example, the designations of different elements in the manner described is meant to help explain concepts described herein and is not limiting. Further, the diagram 200 may include any number of other elements or may be implemented within other systems or contexts than those described. For example, any of the components of FIG. 2 may be divided into additional or combined into fewer components.

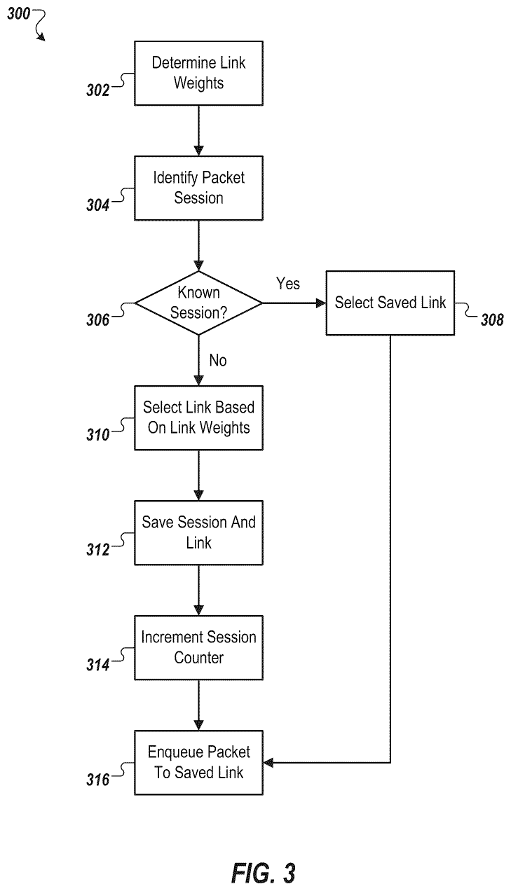

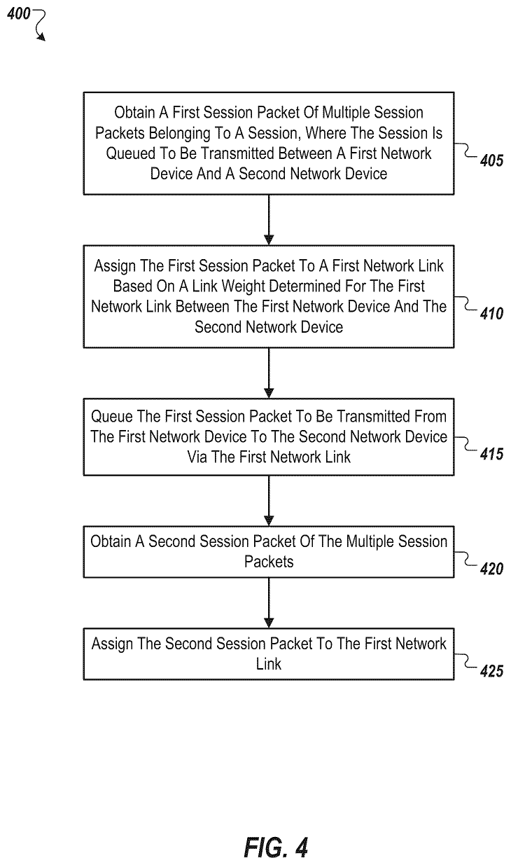

FIG. 3 and FIG. 4 illustrate flowcharts of an example method 300 and an example method 400, respectively, of session-based load balancing, in accordance with at least one embodiment of the present disclosure. The method 300 and/or the method 400 may be performed by processing logic that may include hardware (circuitry, dedicated logic, etc.), software (such as is run on a general purpose computer system or a dedicated machine), or a combination of both, which processing logic may be included in any computer system or device such as the first device 105 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 302, an initialization of a system may be performed. In some instances, the initialization may include determining initial link weights for each transmit link and/or channel included in the system. For example, a first link weight may be determined for a first channel, a second link weights may be determined for a second channel, and so forth. The link weights may be determined using at least one of the computations described herein. Alternatively, or additionally, the link weights may be periodically recalculated at any point after initialization, as described herein. For example, upon satisfying a threshold period of time, the link weights may be recalculated. In another example, upon satisfying a threshold number of transmitted session packets, the link weights may be recalculated.

At block 304, a transmit device (such as the first device 105 of FIG. 1) may be operable to obtain a particular session packet belonging to a particular session. For example, the particular session packet may be stored in an ingress queue associated with the transmit device and the transmit device may obtain the particular session packet from the ingress queue. In some instances, the transmit device may be operable to identify the particular session to which the particular session packet may belong. For example, in instances in which the particular session packet of a first session arrives at an ingress queue of the transmit device, the transmit device may determine the particular session packet belongs to the first session.

At block 306, a determination regarding the first session to which the first session packet belongs may be made. In instances in which the first session packet is included in a known session, the method 300 may continue at block 308. In instances in which the first session packet is not included in a known session, the method 300 may continue at block 310. For example, the transmit device may identify the particular session packet as a first session packet belonging to the first session, indicating the relationship of the first session packet to the first session, which may also indicated that the first session may not be a known session. A known session may describe any session that includes one or more session packets that may have been obtained by the transmit device, and where the transmit device may have saved the configuration of the session packets to a particular transmit link and/or channel associated with the transmit device. In instances in which a particular session was known, and the configuration was subsequently erased, as described herein, the particular session may not be a known session after the configuration is erased.

At block 308, the transmit device may select the transmit link and/or the channel associated with the particular session packet that may have been previously determined, assigned, and/or saved. For example, a configuration of the assignment of the first session packet belonging to the first session may be saved such that when the transmit device obtains a second session packet belonging to the first session, the transmit device may assign the second session packet to the same transmit link and/or channel as the first session packet, such that all packets belonging to the first session may be assigned to the same transmit link and/or channel. The assignment of the second session packet (and/or subsequent session packets belonging to the first session) may be performed without additional computations relative to the second session packet or the subsequent session packets belonging to the first session. Following the assignment of the session packet(s) to the known transmit link and/or channel, the method 300 may continue at block 316.

At block 310, the transmit device may determine a particular transmit link and/or particular channel for the particular session packet to be assigned. The determination may be performed in view of the link weights associated with the transmit links and/or channels in the system. For example, a ratio of the link weights may determine which transmit link and/or channel the particular session packet may be assigned, as described herein.

At block 312, the assignment of the particular session packet (and/or the first session) to the particular transmit link and/or particular channel may be saved by the transmit device, such that the transmit device may be operable to assign additional session packets from the first session to the particular link and/or particular channel without performing a computation. The transmit device may be operable to store the configuration of the assignment of the first session and/or any other sessions until the assignment is removed from the transmit device.

At block 314, the transmit device may increment the session counter. By doing so, the transmit device may be operable to store the configuration of the assignment of future session packets to a transmit link and/or channel in the system. In some instances, the transmit device may store the configuration of the assignment of a particular session to a particular transmit link in a table, and by incrementing the session counter, the transmit device may store individual assignments in unique rows in the table.

At block 316, the transmit device may enqueue the particular session packet to the particular link and/or particular channel, which may be the same particular link and/or particular channel as was previously saved by the transmit device, as described herein. The transmit device may proceed with transmitting the particular session packet via the particular link and/or particular channel determine for the particular session packet.

FIG. 4 illustrates a flowchart of the example method 400 of session-based load balancing, in accordance with at least one embodiment of the present disclosure. At block 405, a first session packet of multiple session packets belonging to a session may be obtained. The session may be queued to be transmitted between a first network device and a second network device. In some instances, the session may be a subset of multiple sessions, where each of the multiple sessions may be queued to be transmitted from the first network device to the second network device.

In some instances, the first network link may be a wireless connection. In such instances, the link weight may be determined by obtaining at least a first bandwidth for the first network link and a second bandwidth for a second network link and determining a ratio between the first bandwidth and the second bandwidth. Alternatively, or additionally, the first network link may be a wired connection. In such instances, link weight may be determined by obtaining a first negotiated PHY rate for the first network link and a second negotiated PHY rate for a second network link and determining a ratio between the first negotiated PHY rate and the second negotiated PHY rate.

In some instances, the link weight may be determined by obtaining a first rolling average PHY rate for the first network link and a second rolling average PHY rate for a second network link and determining a ratio between the first rolling average PHY rate and the second rolling average PHY rate. Alternatively, or additionally, the link weight may be determined by obtaining a first rolling average data rate for the first network link and a second rolling average data rate for a second network link and determining a ratio between the first rolling average data rate and the second rolling average data rate.

At block 410, the first session packet may be assigned to a first network link based on a link weight. The link weight may be determined for the first network link between the first network device and the second network device.

At block 415, the first session packet may be queued to be transmitted from the first network device to the second network device via the first network link.

At block 420, a second session packet of the multiple session packets may be obtained.

At block 425, the second session packet may be assigned to the first network link. The second session packet may be assigned to the first network link based on the first session packet being assigned to the first network link.

Modifications, additions, or omissions may be made to the method 400 without departing from the scope of the present disclosure. For example, in some embodiments, a configuration of the assignment of the first session packet to the first network link may be saved. In some instances, the configuration that was saved of the assignment of the first session packet to the first network link may be erased. The configuration may be erased in response to an assignment of a last session packet of the multiple session packets to the first network link.

In another example, the multiple session packets may be transmitting via the first network link. In another example, the link weight may be updated, such as in response to a threshold being satisfied.

In another example, a third session packet of a second multiple session packets belonging to a second session may be obtained. The third session packet may be assigned to a second network link based on a second link weight determined for the second network link between the first network device and the second network device. The third session packet may be queued to be transmitted from the first network device to the second network device via the second network link. A fourth session packet of the second multiple session packets may be obtained and the fourth session packet may be assigned to the second network link. In some instances, the first network link may be the same as the second network link.

In another example, the designations of different elements in the manner described is meant to help explain concepts described herein and is not limiting. Further, the method 400 may include any number of other elements or may be implemented within other systems or contexts than those described.

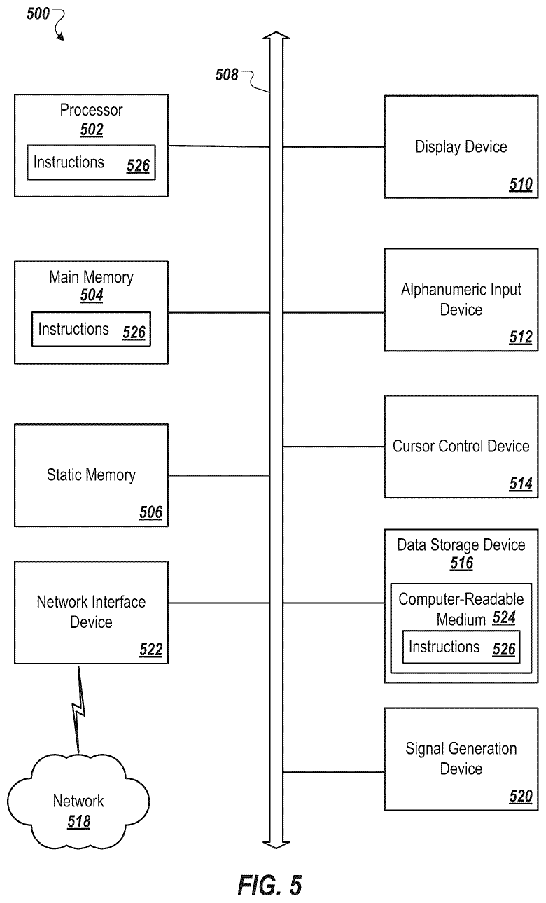

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, an access point, a gateway, a wireless extender, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A device, comprising:
a first network link; and
a second network link, the device operable to:
obtain a first session packet of a plurality of session packets belonging to a session, where the session is queued to be transmitted from the device;
assign the first session packet to the first network link based on a link weight determined for the first network link, the first network link connecting the device to a second device;
queue the first session packet to be transmitted via the first network link;
obtain a second session packet of the plurality of session packets; and
assign the second session packet to the first network link.

2. The device of claim 1, wherein the device is further operable to save a configuration of the assignment of the first session packet to the first network link.

3. The device of claim 2, wherein in response to the device assigning a last session packet of the plurality of session packets to the first network link, the device is further operable to erase the configuration that was saved of the assignment of the first session packet to the first network link.

4. The device of claim 1, wherein the first network link is a wireless connection and the link weight is determined by obtaining at least a first bandwidth for the first network link and a second bandwidth for a second network link and determining a ratio between the first bandwidth and the second bandwidth.

5. The device of claim 1, wherein the first network link is a wired connection and the link weight is determined by obtaining a first negotiated physical layer (PHY) rate for the first network link and a second negotiated PHY rate for a second network link and determining a ratio between the first negotiated PHY rate and the second negotiated PHY rate.

6. The system of claim 1, wherein the link weight is determined by obtaining a first rolling average physical layer (PHY) rate for the first network link and a second rolling average PHY rate for a second network link and determining a ratio between the first rolling average PHY rate and the second rolling average PHY rate.

7. The system of claim 1, wherein the link weight is determined by obtaining a first rolling average data rate for the first network link and a second rolling average data rate for a second network link and determining a ratio between the first rolling average data rate and the second rolling average data rate.

8. A method, comprising:
obtaining a first session packet of a plurality of session packets belonging to a session, where the session is queued to be transmitted between a first network device and a second network device;
assigning the first session packet to a first network link based on a link weight determined for the first network link between the first network device and the second network device;
queuing the first session packet to be transmitted from the first network device to the second network device via the first network link;
obtaining a second session packet of the plurality of session packets; and
assigning the second session packet to the first network link.

9. The method of claim 8, further comprising saving a configuration of the assignment of the first session packet to the first network link.

10. The method of claim 9, further comprising in response to assigning a last session packet of the plurality of session packets to the first network link, erasing the configuration that was saved of the assignment of the first session packet to the first network link.

11. The method of claim 8, further comprising transmitting the plurality of session packets via the first network link.

12. The method of claim 8, wherein the session is a subset of a plurality of sessions, and where each of the plurality of sessions are queued to be transmitted from the first network device to the second network device.

13. The method of claim 12, further comprising:
obtaining a third session packet of a second plurality of session packets belonging to a second session;
assigning the third session packet to a second network link based on a second link weight determined for the second network link between the first network device and the second network device;
queuing the third session packet to be transmitted from the first network device to the second network device via the second network link;
obtaining a fourth session packet of the second plurality of session packets; and
assigning the fourth session packet to the second network link.

14. The method of claim 13, wherein the first network link is the same as the second network link.

15. The method of claim 8, wherein the first network link is a wireless connection and the link weight is determined by obtaining at least a first bandwidth for the first network link and a second bandwidth for a second network link and determining a ratio between the first bandwidth and the second bandwidth.

16. The method of claim 8, wherein the first network link is a wired connection and the link weight is determined by obtaining a first negotiated physical layer (PHY) rate for the first network link and a second negotiated PHY rate for a second network link and determining a ratio between the first negotiated PHY rate and the second negotiated PHY rate.

17. The method of claim 8, wherein the link weight is determined by obtaining a first rolling average physical layer (PHY) rate for the first network link and a second rolling average PHY rate for a second network link and determining a ratio between the first rolling average PHY rate and the second rolling average PHY rate.

18. The method of claim 8, wherein the link weight is determined by obtaining a first rolling average data rate for the first network link and a second rolling average data rate for a second network link and determining a ratio between the first rolling average data rate and the second rolling average data rate.

19. The method of claim 8, further comprising in response to satisfying a threshold, updating the link weight.

20. The method of claim 8, wherein the second session packet is assigned to the first network link based on the first session packet being assigned to the first network link.
